(19) United States
(12) Patent Application Publication
(10) Pub. No.: US 2018/0034810 A1
(43) Pub. Date: Feb. 1, 2018

(54) A SYSTEM AND METHODS FOR PROTECTING KEYS IN COMPUTERIZED DEVICES OPERATING VERSUS A SERVER

(71) Applicant: DYADIC SECURITY LTD, Petach Tikva (IL)

(72) Inventors: Guy PE'ER, Talmey Yechiel (IL); Yehuda LINDELL, Givat Shmuel (IL)

(21) Appl. No.: 15/553,768

(22) PCT Filed: Feb. 28, 2016
(86) PCT No.: PCT/IL2016/050226

§ 371 Date: Aug. 25, 2017

Related U.S. Application Data
(60) Provisional application No. 62/121,528, filed on Feb. 27, 2015.

(51) Int. Cl. H04L 29/06; H04L 9/32

(52) U.S. Cl. CPC H04L 63/0838; H04L 63/06; H04L 63/168; H04L 63/0281; H04L 9/3247; H04L 63/061; H04L 63/062

(57) ABSTRACT

The subject matter discloses a computerized system for securing information, comprising a client application installed on a computerized device, said client application stores a first share of the information, a server communicating with the client application, said server stores a second share of the information, an MPC module installed on the client application and on the server, wherein a request to use the information activates the MPC module, such that computation performed by the MPC module enables use of the information while only a share of the information resides on the server or on the computerized device, wherein the server verifies the identity of the computerized device in response to a request to use the information

### FIELD OF THE INVENTION

The present invention generally relates to authentication, more specifically to authentication of computerized devices operating versus third party servers

### BACKGROUND OF THE INVENTION

Cryptographic keys can be stored within a computer units (IE: PC) or a mobile computer device or their peripheral devices, in order to aid multiple operations such as log-in into a computer or a server, digital signing on documents or transactions, approve identity for any authentication process which requires that the claimant prove its identity and so on.

Utilizing cryptographic keys has many advantage over relying on a user password only, since cryptographic keys are long, unique and cannot be guessed or broken nor exploited through using any common hacking practices (IE: Brute force).

Furthermore, utilizing more than one factor such as password plus a cryptographic key achieves a robust authentication or identification processes since an entity is required to prove its identity with more than one mean. Attacker needs to have access to both the password and the cryptographic key storage, located in the computer unit or in the mobile device, to carry out whatever operation. However, computer units and mobile devices are inherently insecure platforms and sensitive information can be extracted from them without permission, especially when end-users use personal, non-managed devices. This insecurity of mobile platforms creates a situation where large efforts are required to be put in order to reinforce the security of the keys' storage. Furthermore, additional administrative operations for managing the keys such as storing keys, replacing keys, erasing keys and more may require a cumbersome configuration which in some cases may permit access for more than one person or entity to the keys' storage located in the device. This increases any system's complexity that designed to fulfill the requirements of securing the keys and their storage while making the keys accessible in a simple fashion to any authorized entity whom is eligible to use them.

It should be noted that naive solutions such as encrypting the password with the PIN are completely useless since it is trivial to try all PINs in an attempt to decrypt and obtain the password.

### SUMMARY OF THE INVENTION

The present invention discloses a system and method for securing cryptographic keys by utilizing a method that splits the cryptographic key into two or more shares and places one share of the key in the computerized device, or a personal computer, a computer unit, and others elsewhere. Another share of the cryptographic key may be stored in a distributed security module (DSM) in which a cluster of servers running the DSM software. The secured use of a cryptographic key, for example authentication of the computerized device, is performed without ever bringing the key shares together, using secure multiparty computation (MPC). Thus, even if the mobile or PC is stolen or infected by malware, the key cannot be extracted nor used. In some cases, in addition to storing the key in two remote devices, the shares of the key may also be updated/refreshed periodically, for example according to a random share. Thus, even if a previous share was stolen, once the refresh takes place, the previous share becomes useless. This severely limits the possible damage in case the key share is stolen or extracted by an attacker.

The two separate shares of information may be created via a variety of methods, as desired by a person skilled in the art. Such methods may include XOR, additive shares, multiplicative shares as examples but the scope of patent protection includes any method of creating the shares.

It is an object of the present invention to disclose a computerized system for securing information, comprising a client application installed on a computerized device, said client application stores a first share of the information, a server communicating with the client application, said server stores a second share of the information, an MPC module installed on the client application and on the server, wherein a request to use the information activates the MPC module, such that computation performed by the MPC module enables use of the information while only a share of the information resides on the server or on the computerized device, wherein the server verifies the identity of the computerized device in response to a request to use the information.

In some cases, the system further comprises an enrollment module configured to perform an enrollment process between the client side and the server.

In some cases, the server verifies the identity of the computerized device in response to every request to use the information from the client side. In some cases, the information is an encryption key. In some cases, the server comprises a storage for storing shares of secret information of multiple computerized devices. In some cases, the server also comprises a verification module to verify the identity of a specific client.

In some cases, the system uses a communication protocol to verify for the computerized device that server is authenticated and holds the relevant share of information. In some cases, the system uses a communication protocol to verify for the server that computerized device is authenticated and holds the relevant share of information. In some cases, the server and the client side comprise a refresh module in which information is refreshed after every security process performed between the client side and the server.

A computerized method for securing information, comprising:

receiving a request in a client side to use information in order to perform a security process, said client application stores a first share of information and a server stores a second share of the information;

a request to use the information activates the MPC module installed on both the server and client side, such that computation performed by the MPC module enables use of the information while only a share of the information resides on the server or on the computerized device;

verifying the identity of the computerized device in response to a request to use the information.

In some cases, the method further comprises performing an MPC computation at the client side. In some cases, the method further comprises verifying identification of the client side and performing an MPC computation at the server side. In some cases, the method further comprises performing an enrollment when the computerized device first registers at the server.

In some cases, the method further comprises performing a refresh process after performing a security process.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced

Referring to FIG. 1, is a functional diagram discloses a system comprises a computerized device and a Distributed Security Module server (DSM) that controls a process of securing password in a computerized device by the server according to exemplary embodiments of the present invention;

Referring to FIG. 2 that discloses an enrollment method of a computerized device in a server, according to exemplary embodiment of the present invention;

Referring FIG. 3 discloses a method of pre-authentication in order to validate that both the DSM server and the computerized device can be mutually trusted according to exemplary embodiments of the present invention;

Referring FIG. 4, which discloses a method of enrolling to a security auxiliary server according to exemplary embodiments of the present invention;

Referring FIG. 5, which discloses a method of performing a security process between the computerized device and the security server, according to exemplary embodiments of the present invention; and,

Referring FIG. 6, which discloses a method of communicating between the computerized device and the security server, according to exemplary embodiments of the present invention;

FIG. 7 discloses a method in which a computerized device uses a password in a security process versus an application server, according to exemplary embodiments of the present invention;

FIG. 8 discloses a method in which a computerized device uses a password in a security process versus an application server without revealing the password, according to exemplary embodiments of the present invention.

### DESCRIPTION OF THE INVENTION

The present invention discloses a system and method that enable secure connections between a server and a computerized device operated by a person, for example a laptop, tablet, cell phone and a PC. In this scenario, a single server provides security services to multiple devices, unlike known solutions in which a server operates versus another server.

The present invention may be used for various security operations, such as one time password (OTP), elliptic curve, RSA, password protection and others. The result of the method is prevention of cloning of mobile devices, security server authenticated by user, no replay of messages (because of counter and refresh of encryption key).

Referring to FIG. 1, is a functional diagram discloses a system comprises a computerized device and a Distributed Security Module (DSM) server that controls a process of securing password in a computerized device by the server according to exemplary embodiments of the present invention. The system comprises a computerized device 130 operated by the user for activities that may require secure communications protected by password or any other secret. Exemplary cases can be purchasing on the internet, approving transactions, signing on documents and the like. The system also contains a Distributed Security Module (DSM) server 140 that conducts the process of securing the user's password or any other secret. The DSM server 140 enables the computerized device 130 to be authenticated at the third party server 160. The DSM server 140 utilizes a method that encrypts user's secret or a token with a cryptographic key that is split into two or more shares, at least one share is stored in the DSM server 140 and at least another share is stored in the computerized Device 130. The computerized Device 130 also contains a device security application 110, which stores the encrypted password and communicates with the DSM server 140.

The DSM server 140 contains an MPC unit 150 configured to perform multiparty computations, for example on the key shares located on both the DSM server 140 and the computerized Device 130. The MPC unit 150 conducts the secure multi-party computation protocol needed for cases in which the DSM server 140 and a computerized device 130 are required to compute any function value without revealing the private values of each side. For example in case the server requires to calculate a key result combined of user device share key and the DSM server's key and each party, the computerized device operated by the user and the DSM server cannot expose the share keys to the other party. The DSM server 140 comprises a Pre Authentication Unit 145 that exchanges cryptographic keys, for example AES keys, with the security application 310, for example prior to any communication between the DSM server 140 and the computerized device 130. The cryptographic keys may be a symmetric keys, such as AES key.

The DSM server 140 also contains a users' key list 125 that stores the shares of the keys provided from user devices communicating with the DSM server 140. The users' key List 125 may contain user names and a share of a keys, each key is associated with a user or a user's device for cases such as password decryption and the like. The DSM server 140 also comprises a users' password list 135 that stores encrypted secrets such as passwords, or shared messages provided by user devices communicating with the DSM server 140, the secrets or messages are associated with a user or a user's device for cases such as a password or a shared message that are needed for a secured communication between the user operates the user device 130 and a third party server 170.

Referring to FIG. 2 that discloses an enrollment method of a computerized device in a server, according to exemplary embodiment of the present invention. The enrollment may be performed on the first time the computerized device connects to the server, in order to enable the server to recognize the computerized device afterwards, for any authentication process with a third party server. The enrollment method utilizes at least some of the following: (1) A unique identifier held by the computerized device, utilized in order to bind a mobile secret data to the server secret data. (2) A counter held by the computerized device to verify the same key version is used, as the key may be refreshed periodically or in response to a predefined event. (3) A message counter held by both sides, the server and by the computerized device, in order to prevent message replay between the computerized device and the server. (4) Username provided by the user when log in to the computerized device and saved for auditing purposes. (5) A cryptographic key, such as AES key, utilized as a shared secret between the computerized device and the DSM server in order to encrypt and decrypt. (6) Biometric data—denotes a digital expression represents a biometric data, such as a fingerprint, which may be utilized for authentication process. (7) PIN (Personal Identification Number) received from the user of the computerized device.

In the first phase of the enrollment, the computerized device obtains or generates information required to be unique by the DSM server. Step 200 discloses a computerized device generating information specific to the device, such as unique identifier (item 1 of the paragraph above), an AES key (item 5 of the paragraph above) and a random value known only to the computerized device. In step 205, the computerized device receiving a PIN or swipe pattern and/or a Username from the user of the device. In step 210, the computerized device uses the touch ID, or the PIN or the user's swipe to create a message to be sent to the server. If the touch ID is used, the message is signed and the server verifies the signature. If PIN or Swipe is used, it is included in the hash value sent to the server, and the server verifies the hash. Then, the computerized device stores the private key. In step 215, the computerized device obtains biometric information from the user, for example a biometric fingerprint.

In step 220, the computerized device communicates with the server and establishes a connection channel via the DSM server. The connection channel may be a secured channel, for example using connections based on Transport Layer Security (TLS) protocol or a Secure Sockets Layer (SSL) protocol.

In step 225, the computerized device computes a hash value using at least some of the information obtained or generated above, such as the PIN, computerized device unique identifier, and the random value known only to the computerized device. The information used to compute the hash value may be determined according to user ID, authentication type, type of the user's device and the like.

In step 230, the computerized device encrypts the information to be sent to the server using the server public key. Such information may include the following: The unique identifier, The Username, the AES key, the touch ID's digital signature public key, the hash value retrieved in step 225, the PIN's digital signature public key and the like. In step 232, the computerized device sends the encrypted information to the server.

Step 235 discloses the server receiving the content sent by the computerized device in step 230. Then, in step 240, the server decrypts the content, reveals the hash value which was calculated by the computerized device, and in step 245 the server computes a second hash value using the computerized device hash value as an input. Then, in step 250 the server sets the key version to “0” (Zero) and the message counter to “0” (zero). In step 255, the computerized device sets the key version, to “0” (Zero) and the message counter to “0” (zero).

Referring FIG. 3 discloses a method of pre-authentication in order to validate that both the DSM server and the computerized device can be mutually trusted according to exemplary embodiments of the present invention. The process is as the following: In step 305, the computerized device and the DSM server share a symmetric key. In step 310 the user who operates a computerized device establishes a secure connection with the DSM server utilizing the public key of the security server. This process can be for example cases of using connections based on Transport Layer Security (TLS) protocol or a Secure Sockets Layer (SSL) protocol. In step 320 a plain message contains data produced by the computerized device, such data can be a unique text, timestamp, or any data other information the device agrees to utilize as a plain message. Then the computerized device encrypts the plain message to a code utilizing the symmetric key shared with the DSM server. In step 330 the computerized device transmits the message code together with the message encrypted with a key known to both the server and the computerized device to the DSM server via the secure connection. In step 340 the server validates the message authenticity by decrypting the message code with the symmetric key.

In step 350, in case the messages are identical, both parties, the security server and the computerized device, can be trusted and the computerized is defined as entitled to communicate with the server. In Step 360 the security server and the computerized device produce new symmetric keys and store them, one at computerized device side and one at the server.

Referring FIG. 4, which discloses a method of enrolling to a security auxiliary server according to exemplary embodiments of the present invention. The method discloses enrolling to a security server using a password received from the user, as discloses in step 400. In step 410, the user's computerized devices generates half of the encryption key, for example an elliptical curve encryption key. Step 420 discloses generating two shares of the password, for example XOR shares. In step 425, one share of the password is stored in the computerized device. Then, in step 430, the encryption key is executed on the password using first key share. In step 440, the computerized device sends a public part of mobile key, second share and result of encryption to security auxiliary server. Then, in step 450, the security server generates server half key. In step 455, the server encrypts the second share of the password using server half key, and then stores the encrypted value on the server, as disclosed in step 460.

Referring FIG. 5, which discloses a method of sending, executing and returning a message between the computerized device and the security server, according to exemplary embodiments of the present invention. Step 500 discloses generating a specific protocol payload for server. Step 505 discloses incrementing message counter in the client side. The message counter has an equivalent for each computerized device communicating with the server at the server side. Step 510 discloses generating a message of refresh protocol. The refresh protocol is another mechanism for strengthening the verification that the client is indeed trusted, and the server is the correct server. Step 515 discloses computing a hash function using a unique ID and PIN of the user of the computerized device as an input. Step 520 discloses sending an encrypted payload, including hash result, counter and refresh encrypted and key unique ID and key version in plain, unencrypted. Step 530 discloses the server finds relevant token from DB according to information received from client side. Step 535 discloses decrypting information sent from the client side, and verify that client used the proper AES key.

In step 540 the server verifies that the counter is correct, higher than server counter. In step 545 the server computes a hash function using the result of the hash computed by the client side, and compares the result to a result stored in the database of the server. Then, in step 550, specific protocol is activated with decrypted payload. In step 555 the server generating second refresh message. Step 560 discloses encrypting returned payload. Step 565 discloses—Incrementing key version and updating key, updating key version for specific computerized device communicating with the server. Step 570 discloses sending encrypted payload and refresh data from the server to computerized device. Step 575 discloses the computerized device decrypting payload at client side, and step 580 discloses completing the refresh by the client side. Then, in step 585, the incremented version of the information is stored on the client side, for the next process versus the server.

Referring FIG. 6, which discloses a method of communicating between the computerized device and the security server, according to exemplary embodiments of the present invention. Step 600 discloses receiving a request in a client side to use information in order to perform a security process, said client application stores a first share of information and a server stores a second share of the information. Step 610 discloses activating the MPC module installed on both the server and client side in response to receipt of the request, such that computation performed by the MPC module enables use of the information while only a share of the information resides on the server or on the computerized device. Step 620 discloses verifying the identity of the computerized device in response to a request to use the information. Step 630 discloses performing an MPC computation at the client side. Step 640 discloses verifying identification of the client side and performing an MPC computation at the server side. Step 650 discloses performing an enrollment process when the computerized device first registers at the server. Step 660 discloses performing a refresh process after performing a security process.

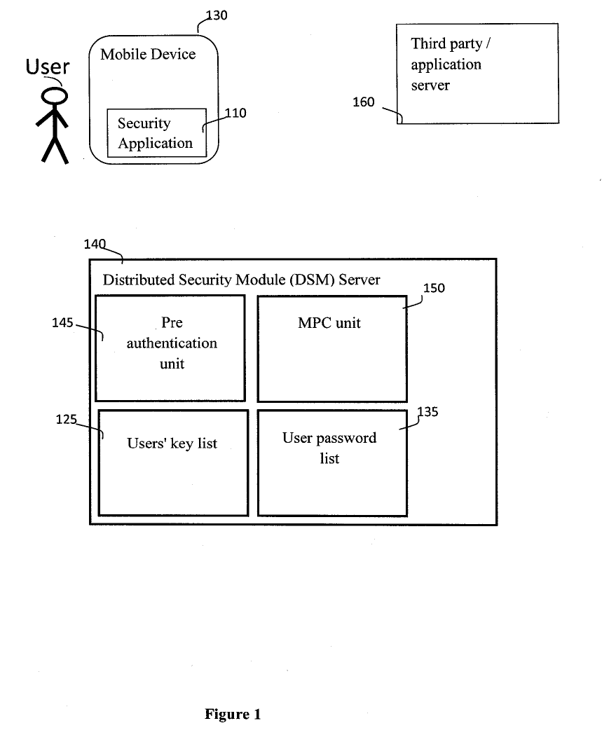

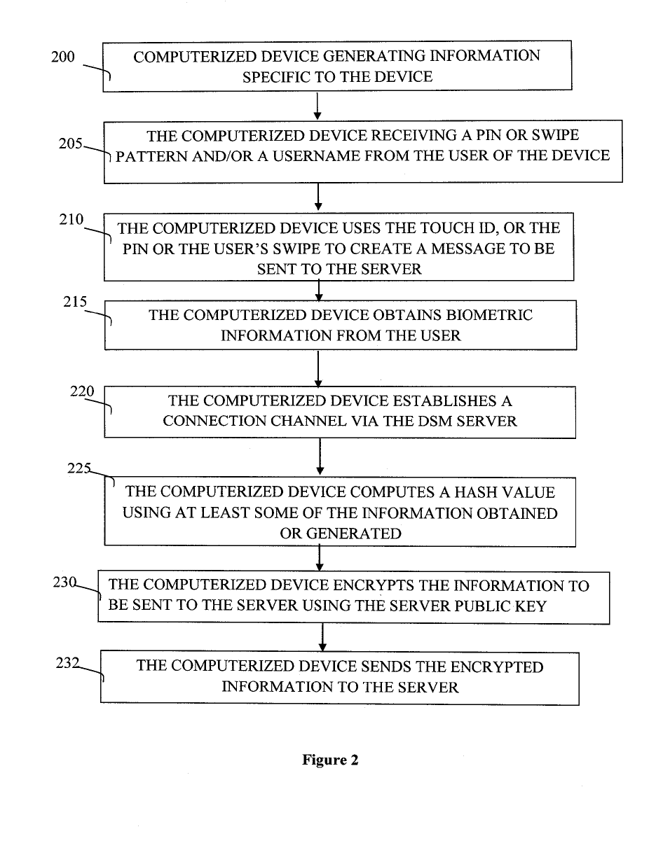

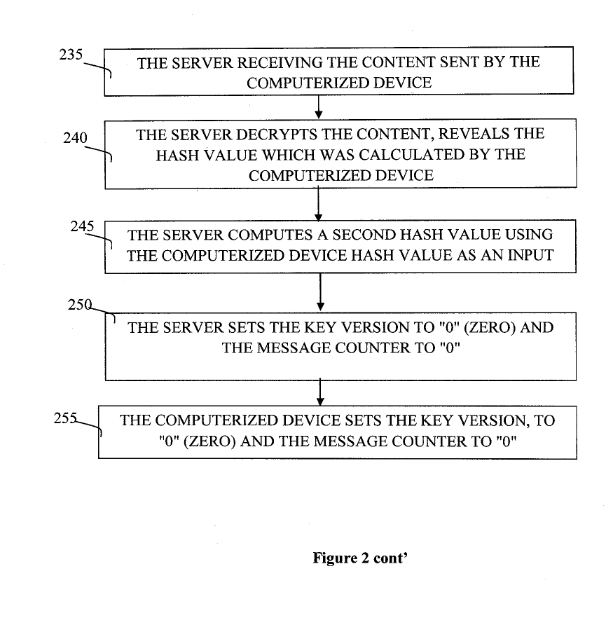

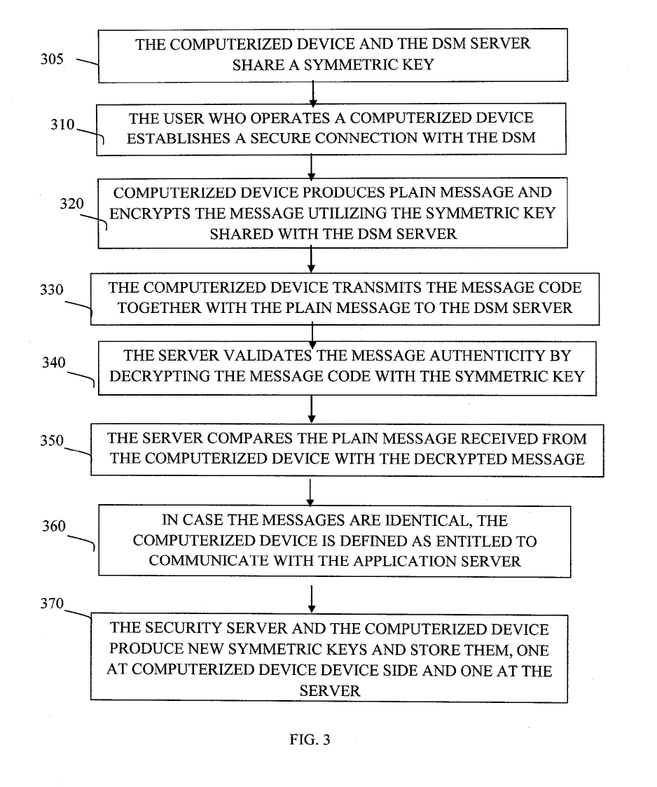

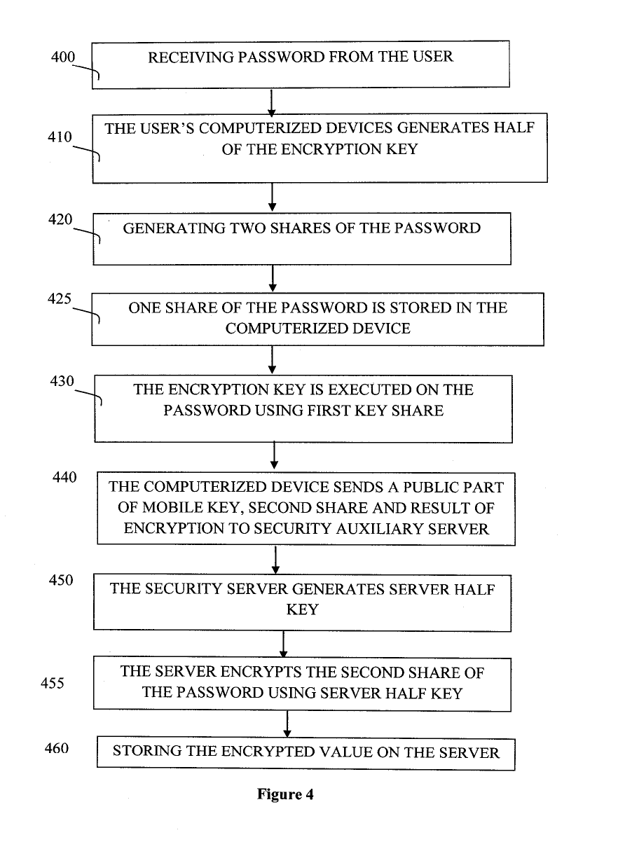

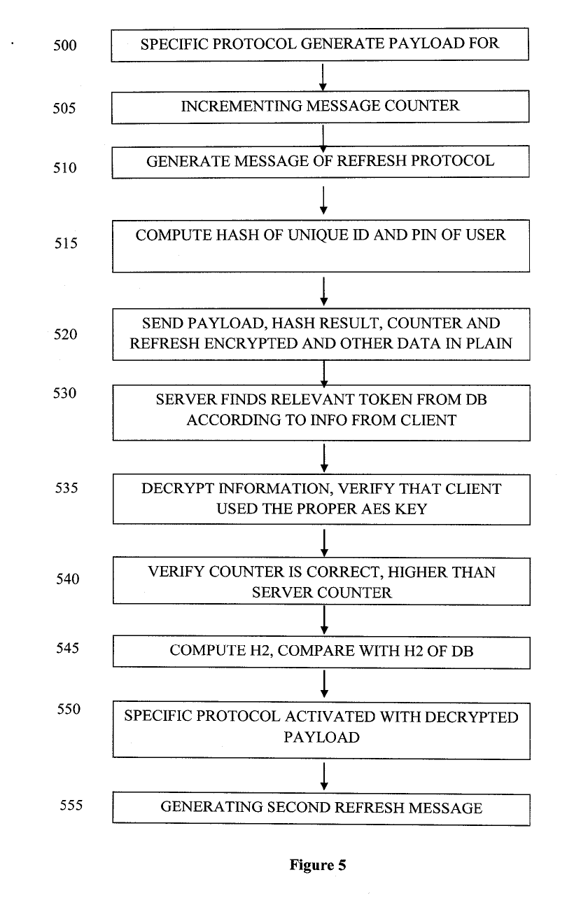

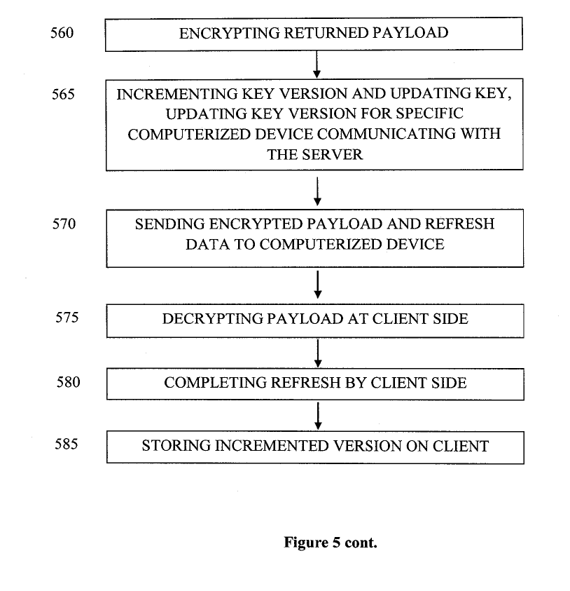

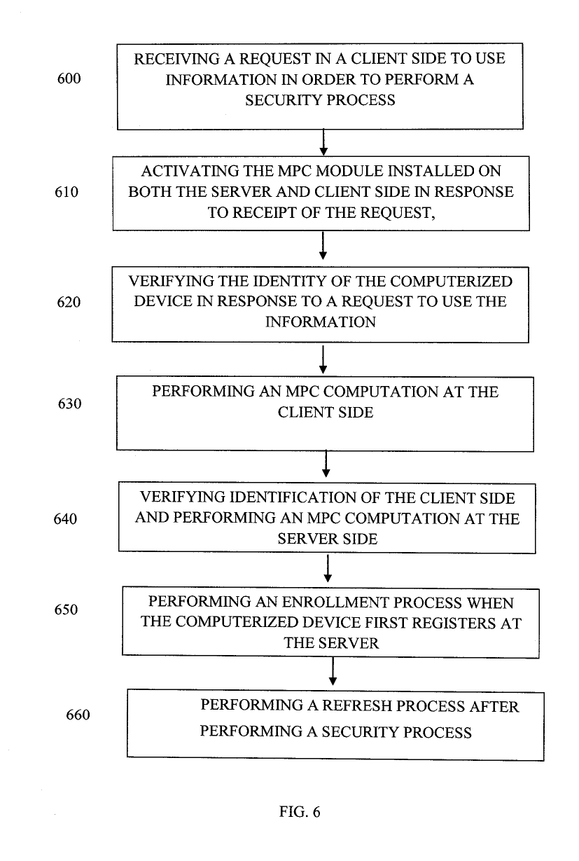

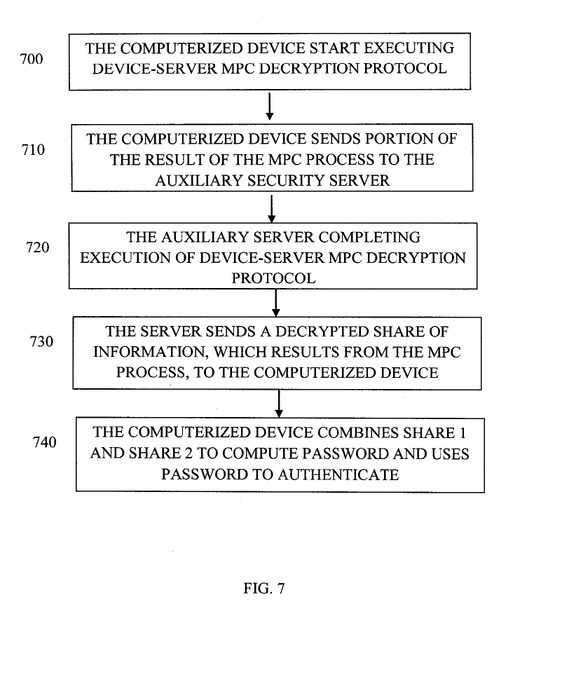

FIG. 7 discloses a method in which a computerized device uses a password in a security process versus an application server, according to exemplary embodiments of the present invention. In step 700, the computerized device start executing device-server MPC decryption protocol. In step 710, the computerized device sends portion of the result of the MPC process to the auxiliary security server. In step 720, the auxiliary server completing execution of device-server MPC decryption protocol. Then, in step 730, the server sends a decrypted share of information, which results from the MPC process, to the computerized device. In step 740, the computerized device combines share 1 and share 2 to compute password and uses password to authenticate.

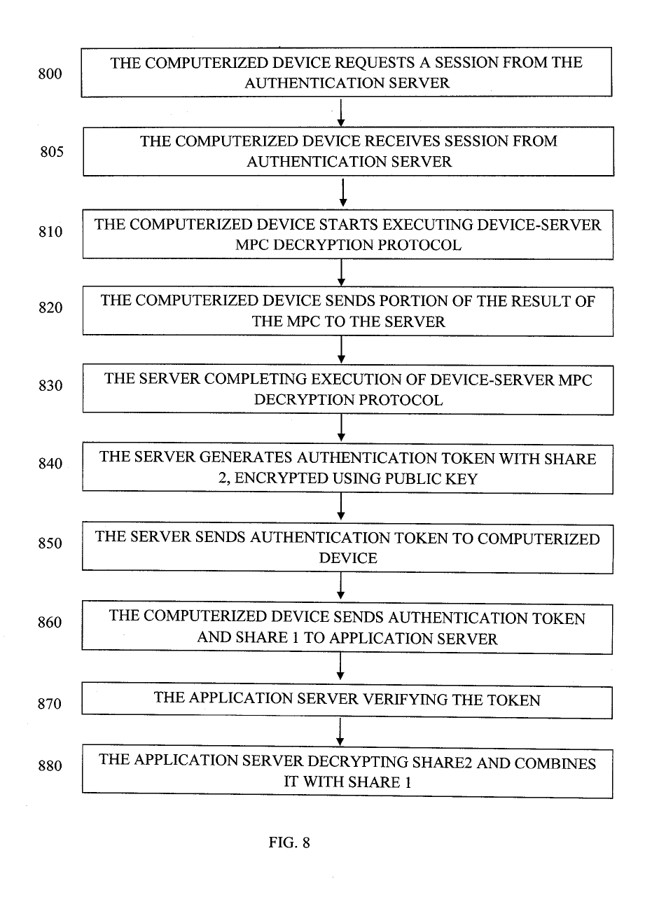

FIG. 8 discloses a method in which a computerized device uses a password in a security process versus an application server without revealing the password, according to exemplary embodiments of the present invention. In step 800, the computerized device requests a session from the authentication server. In step 805, the computerized device receives session from authentication server. In step 810, the computerized device starts executing device-server MPC decryption protocol. In step 820, the computerized device sends portion of the result of the MPC to the server. In step 830, the server completing execution of device-server MPC decryption protocol. In step 840, the server generates authentication token with share 2, encrypted using public key. Then, in step 850, the server sends authentication token to computerized device. In step 860, the computerized device sends authentication token and share 1 to application server. In step 870, the application server verifying the token. In step 880, the application server decrypting share2 and combines it with share 1. The application server received the share from the security server as part of the authentication token on step 850

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this invention, but only by the claims that follow.

1. A computerized system for securing information, comprising:
a client application installed on a computerized device, said client application stores a first share of the information;
a server communicating with the client application, said server stores a second share of the information;
an MPC module installed on the client application and on the server;
wherein a request to use the information activates the MPC module, such that computation performed by the MPC module enables use of the information while only a share of the information resides on the server or on the computerized device;
wherein the server verifies the identity of the computerized device in response to a request to use the information.

2. The system of claim 1, further comprises an enrollment module configured to perform an enrollment process between the client side and the server.

3. The system of claim 1, wherein the server verifies the identity of the computerized device in response to every request to use the information from the client side.

4. The system of claim 1, wherein the information is an encryption key.

5. The system of claim 1, wherein the server comprises a storage for storing shares of secret information of multiple computerized devices.

6. The system of claim 1, wherein the server also comprises a verification module to verify the identity of a specific client.

7. The system of claim 1, wherein using a communication protocol to verify for the computerized device that server is authenticated and holds the relevant share of information.

8. The system of claim 1, wherein using a communication protocol to verify for the server that computerized device is authenticated and holds the relevant share of information.

9. The system of claim 1, wherein the server and the client side comprise a refresh module in which information is refreshed after every security process performed between the client side and the server.

10. A computerized method for securing information, comprising:
receiving a request in a client side to use information in order to perform a security process, said client application stores a first share of information and a server stores a second share of the information;
a request to use the information activates the MPC module installed on both the server and client side, such that computation performed by the MPC module enables use of the information while only a share of the information resides on the server or on the computerized device;
verifying the identity of the computerized device in response to a request to use the information.

11. The method of claim 10, further comprises performing an MPC computation at the client side.

12. The method of claim 10, further comprises verifying identification of the client side and performing an MPC computation at the server side.

13. The method of claim 10, further comprises performing an enrollment when the computerized device first registers at the server.

14. The method of claim 10, further comprises performing a refresh process after performing a security process.
